(19) United States
(12) Patent Application Publication
(10) Pub. No.: US 2007/0130112 A1
(43) Pub. Date: Jun. 7, 2007

(54) Multimedia conceptual search system and associated search method

(75) Inventor: Julius J.Y. Lin, Cupertino, CA (US)

Correspondence Address: TROXELL LAW OFFICE PLLC;SUITE 1404, 5205 LEESBURG PIKE, FALLS CHURCH, VA, 22041, US

(73) Assignee: IntelligenTek Corp.

(21) Appl. No.: 11/543,899

(22) Filed: Oct. 6, 2006

Related U.S. Application Data
(63) Continuation-in-part of application No. 11/174,348, filed on Jun. 30, 2005.

(51) Int. Cl. G06F 17/30

(52) U.S. Cl. 707/2

(57) ABSTRACT

The current disclosure uses the disciplines of Ontology and Epistemology to implement a context/content-based “multimedia conceptual search and planning”, in which the formation of conceptualization is supported by embedding multimedia sensation and perception into a hybrid database. The disclosed system comprises: 1) A hybrid database model to host concept setup. 2) A graphic user interface to let user freely issue searching request in text and graphic mode. 3) A parsing engine conducting the best match between user query and dictionaries, analyzing queried images, detecting and presenting shape and chroma, extracting features/texture of an object. (4) A translation engine built for search engine and inference engine in text and graphic mode. 5) A search engine using partitioned, parallel, hashed indexes from web crawler result, conducting search in formal/natural language in text and graphic mode. 6) A logic interference engine working in text and graphic mode, and 7) A learning/feedback interface.

### REFERENCE TO RELATED APPLICATION

This application is a continuation-in-part of application with Ser. No. 11/174,348, filed Jun. 30, 2005, now U.S. Pub. No. 2005/0264527.

### BACKGROUND OF INVENTION

1. Field of Invention

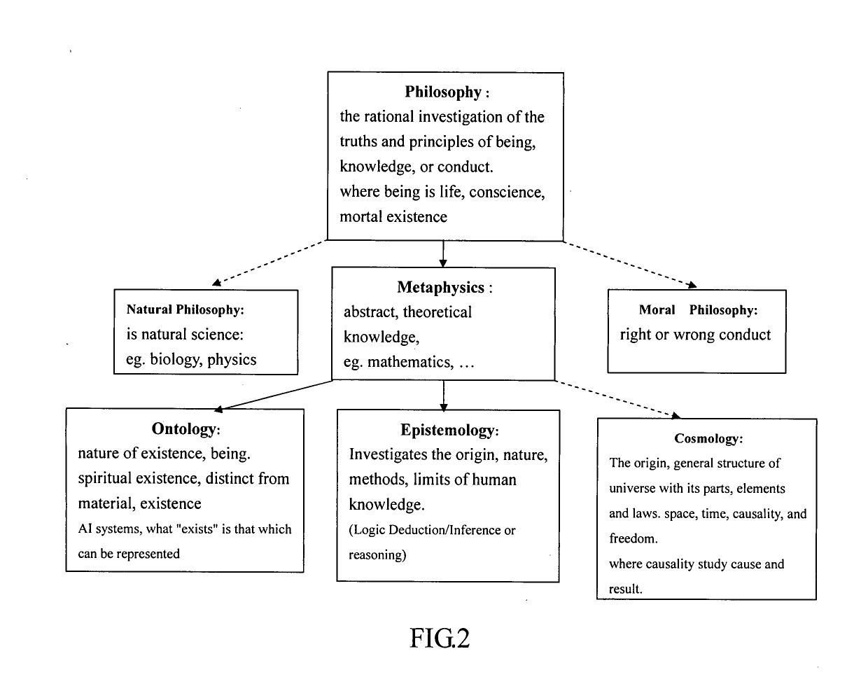

The present invention is generally an implementation of machine intelligence use Metaphysics related disciplines (see Epistemology and Ontology in FIG. 2). So the present invention first creates a method to represent “being” in Ontology discipline.

More specifically, the present invention teaches machine to understand (cognition) various types of media and perform logical deduction not just from data level but from an abstract level.

In particular, the underline technology mentioned above can support a conceptual search on vast amount of media through Internet or intranet.

This conceptual search provides much more precision by enhance the true (e.g. true positive) returns and reduce the false returns (e.g. false positive and false negative).

2. Description of Prior Art

Search capability is an essential part of computerization; whether it is in structured database search (e.g. Select statement of SQL (Structured Query Language) or ad hoc search on the unstructured media (e.g. web pages, articles, images, and video), this retrieval functionality is an indispensable part of our daily life.

Text base search in database was well developed since 1970s and still flourish today, among them, Oracle, Sybase, Informix, Ingres are the most dominate RDBMS systems.

They also evolved into object-relational database. Open source also become trend of this type of database such as PostgreSQL 8.1 (http://www.postgresql.org). Among Oracle UltraSearch is another way to index and search database tables, websites, files, Oracle Application Server portals, and other data sources. Oracle Ultra Search uses a crawler to index documents and builds an index in the designated Oracle database. It allows concept searching and theme analysis, and supports full globalization including Unicode. Oracle's concept searching and theme analysis use automatic classification of documents by subject, Automatic classification is made possible by natural-language processing using an extensive dictionary. Oracle has failed with multiple initiatives in the search space, from Context Option, to Multimedia, to Ultra Search. (http://www.delphiweb.com/knowledgebase/newsflash guest.htm?nid=978 06/28/2005).

Content-based image retrieval (CBIR) had being researched for image and video search, especially for surveillance cameras user input semantic retrieval request, such as “find how the cat escape from the cage” or even “find pictures of Helen Hunt”, moreover, Oracle also licensed from viisage.com as its intermedia database option since Oracle8i (1999), but it is static, two-dimensional images with limited capability in automate metadata extraction and basic image processing (Oracle 10g R.2 as of today) (http://www.csee.umbc.edu/help/oracle8/inter.815/a67293/vir cbr.htm#605494)

The 3D face recognition is developed since in the late 1980s. Critics of the technology complain that the L B Newham scheme has, as of 2004, never recognized a single criminal, despite several criminals in the system's database living in the Borough and the system having been running for several years. An experiment by the local police department in Tampa, Fla., had similarly disappointing results. See http://en.wikipedia.org/wiki/Facial recognition system.

Another group of unstructured data search engines evolved since 1990s Internet boom. Google, Yahoo, MSN, AOL, Lycos and Ask Jeeves are the most prominent first line Internet search engine companies; they provide this type of service to quickly scan through their locally cached data by keyword search. Among them, AskJeeves.com is the most popular natural language query site today, which parses the query for keywords that it then applies to the index of sites it has built. It only works with simple queries.

Recent development of further unstructured data search alternatives is listed below, though still based on the first line of search engines mentioned above. The alternatives are:

A. Meta Search Engine:

1. Sep. 22, 2005—A new meta search engine allows you to compare results from the four top web search engines, and tweak their relative importance in the mix by adding to or subtracting from the relative importance (http://searchenginewatch.com/).
2. Sep. 14, 2005, GoFish Launches Web Media Search The folks at GoFish have launched a new search engine designed to find all kinds of media from all over the Internet. It's called Search WebMedia, available at http://www.searchwebmedia.com/index.html.
3. www.Mamma.com is a “smart” meta search engine—every time you type in a query Mamma simultaneously searches a variety of engines, directories, and deep content sites, properly formats the words and syntax for each, compiles their results in a virtual database, eliminates duplicates, and displays them in a uniform manner according to relevance. It's like using multiple search engines, all at the same time. Its rSort, a simplified version of the “Condorcet Method”, works like a voting system for search results.
   B. Dynamic Query Suggestion Tool:
1. On Sep. 19, 2005, SurfWax (http://lookahead.surfwax.com/) is introducing a dynamic query suggestion tool that can be easily installed and customized on any web site. Before Google offered its popular Google Suggest tool, Silicon Valley's SurfWax was offering dynamic search navigation technology called LookAhead for developing your site's lexicon.
   C. Taxonomies Search:
1. Manual: Search marketing can be complicated: Ads that are animated, display ads, banner ads, classified. Sometimes it's very confusing to figure out how to make the best use of your money. The value of a ZIPMouse.com is that it has developed a way to create local opportunities for companies. Local search is something that neither Google nor Yahoo! has been able to firm up. Instead of a typical Web search, which can deliver millions of results, ZIPMouse brings users information by categories (not keyword) or “shelves”, which can then be researched into even deeper categories or “taxonomies” of information
2. Automatic: Traditional concept-based search systems try to determine what you mean, not just what you say. Ideally, a concept-based search returns information “about” the subject/theme relate to your query, even the words in the document don't precisely match the query you entered. Many of this type of context classification typically use [kernel method] SVM (Support Vector Machine) technology on natural language, plus look at hyperlink, <title>PageTitle</tile> and anchor words (Web classification using support vector machine).

First, the latest development on Meta Search, Query Suggestion and Taxonomies Search try to reduce the inaccurate result generated by the first line search engine, Even though such effort of improvement are made but there is a fundamental issue of keyword search, in that
1) Keywords matched may not be the target you are searching for, because each keyword can have multiple meanings and multiple grammar belongingness, this situation creates so call false positive, that is, the data reported positive isn't real positive, that is why you got lots of unwanted data return from search engine as of today.
2) While same searched target may be represented by other alternatives expressions, which can be a simple synonym, a double negate (with antonym), phrases or sentences in the form of regular expression. Unable to grasp these expressions cause so call false negative, that is, data reported mismatched is actually a good match. That is why the data you are searching for do not return.

Below are examples of queries on Aug. 25, 2005 and Sep. 25, 2005 from dominating search engines:
Experiment in Google:
   Even advance search option take the what or why but is actually ignored during search
   what is RF Results 1-10 of about 17,800,000 for what is RF. (0.05 seconds) (tested on Aug. 25, 2005
   what is RF Results 1-10 of about 43,400,000 for what is RF. (0.27 seconds) (tested on Sep. 25, 2005
   “what is RF” Results 1-10 of about 2,380 for “what is RF”. (0.15 seconds) (tested″″ on Sep. 25, 2005
   why RF Results 1-10 of about 15,800,000 for why RF. (0.25 seconds) (tested on Aug. 25, 2005
   why RF Results 1-10 of about 43,300,000 for why RF. (0.28 seconds) (tested on Sep. 25, 2005
   “why RF” Results 1-10 of about 742 for “why RF”. (0.20 seconds) (tested″″ on Sep. 25, 2005
   Note, Google require double quote around what is or why as mentioned above, else Google ignore them.
   Google's keyword search mistakes “RF” as adjective/modifier. Such as ‘RF safety’, ‘RF cafe’, ‘RF Magazine’, most of the returns are false positives, etc.
Experiment in Yahoo:
   what is RF Results 1-10 of about 52,200,000 for what is RF. (0.17 seconds) (tested on Aug. 25, 2005
   what is RF Results 1-10 of about 53,100,000 for what is RF. (0.14 seconds) (test again Sep. 25, 2005

Yahoo is different from Google in that it takes “what is” or why into account automatically without the need of double quotes, but it doesn't return other possible form of “phrase” or “sentence” that express the same intention (concept, ), again same mistakes on RF by treating RF as adjective or modifier and return overwhelming unwanted data,

It is hard for people to lookup details more then couple dozens of web sites or articles to actually confirm and retrieve information they want, if search engine can't return relevant information to user, after scan through tens of web sites or articles, if you can't get it, they became fatigue and lose confidence of the returned results. Excessive returned data become annoying and useless.

In order to solve such false positive and false negative problems that today's users suffered, the current invention present this “conceptual search” technique to relief the issue by attacking its fundamental.

### SUMMARY OF THE INVENTION

The present invention suggests a robust and precise way of identifying a concept, and use concept to search several of media types (text, audio, and video) and formats of the types.

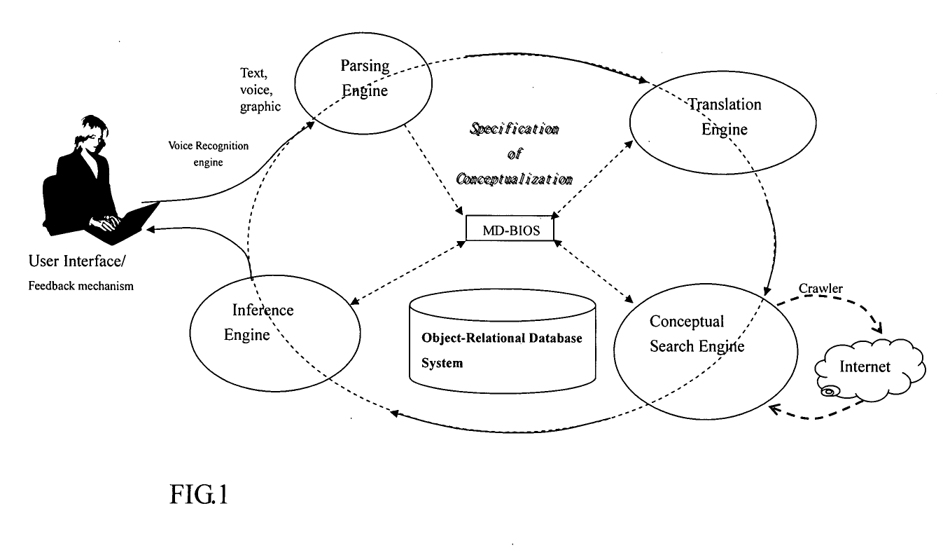

The key ingredient of this invention is the representation of the ‘Specification of Conceptualization’ and methods to hash/index and process them in a timely manner. It is the common foundation of all engines (FIG. 1). The ‘specification’ enable the system to ‘abstract’ its understanding of the ‘nature of existence’ of a being, in other words, if it ‘exists’, it can be represented, which we'll use set and symbolic logic to represent its existence, use predicates logic to depict its properties and relationship and rules of inference to transform/transport its position along the decision tree.

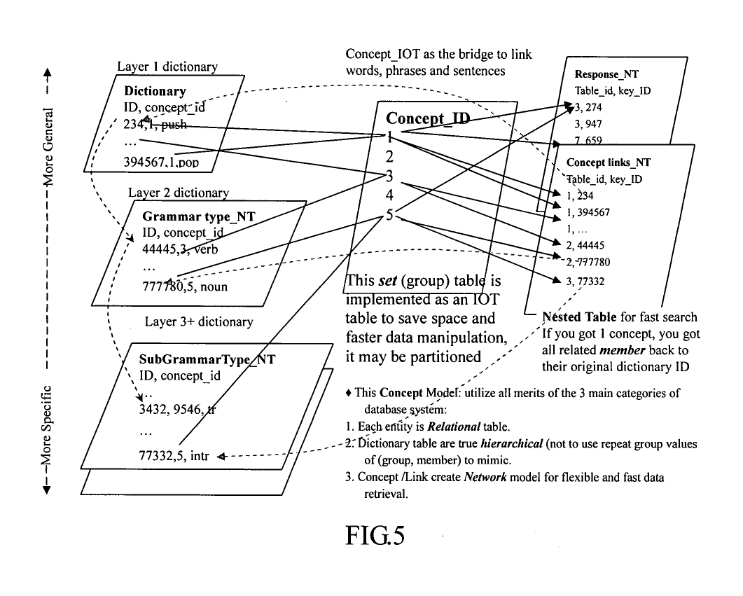

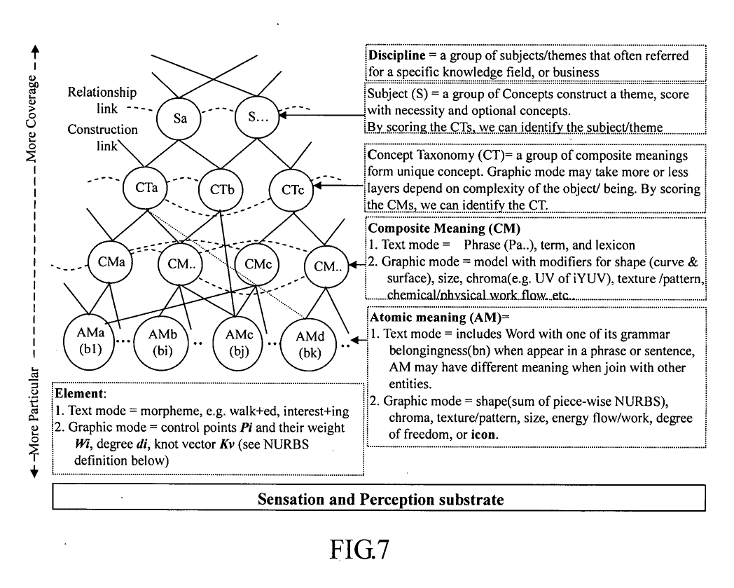

We created an object-relational database to hold data, rules and knowledge, put various dictionaries (not limited to natural language) in a networking of nodes (FIG. 5), and teach/setup relationship between the nodes for the search and inference engines. FIG. 2 provides and overview of components in the system and data flow and interaction among them, below is the summary of its general processing flow:
1. A hybrid (hierarchical, relational and network) database model to host dictionaries (FIG. 5), which is specifically setup for identifying the grammar belongingness of each word. The model can also host other types of concept expressed as visual, aural, tactile, smell and taste data, the concepts are not just expressed in locale natural language, but also any formal language (languages that aren't ambiguous) that can be used to represent the concept, such as mathematics, computer programming languages, especially in object-oriented, organic or neuro-network styles. If a language is used, an underline interpreter/processor for computer was also built.
2. A graphic user interface: user issue searching request in their natural language (text or voice) or specific object query samples (audio-visual 3D, graphic media) through user interface, the UI is design to let user fully express their intention in the most precise way.
3. The Parsing Engine:
   A) Parsing in Text mode:
      It conducts the best match between user query and dictionary. It reads through input data (sentence[s], phrase[s] or word[s] with the locale) from a human interactively or text by batches, and then uses locale grammar to parse the sentences or phrases, identify the belongingness of the words in term of verb (tr., intr.), noun, adjective, adverb, subject, object, interrogative, etc. . . .
   B) Parsing in Graphic mode:
      It analyzes queried graphic/images, detects and presents edge and chroma, extract features/texture of an object in 2D represented by curve of NURBS (Non-Uniform Rational B-Spline).
      i) edge shape : after LoG (Laplacian of Gaussian) edges are detected and scaled, use NURBS (Non-Uniform Rational B-Splines) to represent its control points and feature shapes, because NURBS is invariant under affine as well as perspective transformations, then
      ii) Color: by using UV of xYUV format (eg. iYUV, YUV), unlike RGB, chroma UV is much precise and less sensitive to lighting condition.
      Voice message can be in both text mode (if voice recognition engine (e.g. http://www.neuvoice.com/) can translate the sound wave pattern to text), and graphic mode (if voice recognition engine can't find a match or the sound isn't part of natural language).
4. The Translation Engine:
   It works under both text mode and graphic mode for both search engine and inference engine.
   It walks through the concept model database, finds all of members link to the same concept set, and pass down to search engine or inference engine.
   A) Translate for search engine:
      i. In text Mode:
         It finds the concept links, and gets “the other phrases, sentences or Regular Expression” that representation the same ‘concept’, where “the other words, phrases, sentences or Regular Expression”” are the members of the “abstraction” set. Technically, they are the components in FIG. 7 start from the concept node and transverse down the hybrid nodes. They are the data that instantiate the concept abstraction into instances of keywords, phrases, sentence or Regular Expression with the right belongingness (similar to the polymorphism of object-programming).
         E.g. the RF in ‘What is RF?’ is a noun, while the RF in ‘Is RF safety really important?’ act as an adjective, RF here is an attribute of safety. These individual concept linked expressions will drive the machine intelligence by construction links and relationship links.
      ii. In graphic mode:
         Generally it translate scaling and rotation information for conducting a 2D search; if 3D search is available by using 2 or more images at complementary angles or by sketch, 3D search can produce most accurate result but require more resource to reconstruct 3D model and use projection (perspective view) matching score to find optimal target images by shape, chroma and texture neutral to lighting condition.
   B) Translate for inference engine:
      i. In text Mode:
         Mostly process logic operator ‘and’, ‘or’, ‘not’, and parentheses etc., but can be extended to process predicate logic for more complicate query. It organized the words into terms base on grammar belongingness and use symbols to represent them.
         e.g. simple logic can be ‘find a gene co-exists in strawberry and fish’ can be represented by “G⊂S & F” return true, where G=gene, S=strawberry and F=fish', and ‘&’ represent co-exists. Another example is “RF is part of the lower EM wave”, which may be represent as “A⊂B”, where A is “RF” and B is “the lower EM wave”. While
         This is for the inference engine to use predicate calculus, rules of inference and other form of logic deduction/induction to reason.
      ii. In graphic mode:
         We use Dynamic Spatial Relation to search graphic objects after merge the result from search engine in graphic mode include video streams. This was outline by the inventor's previous patents, Audio-Visual 3D Input/Output, that each object control point has format of object (id, cpID, x,y,z, o[x,y,z], t), base on the basic information, the properties or/and relationship of objects can be identified.

The translation engine is designed as a layer to support existing searching infrastructure and provide the key intelligent ingredient for the general public. Since most user don't care about how fast (0.1 sec or 1 minute) the dominant search engines return or how many (50 millions or just 20) websites/links or articles return, because user may spend hours navigate the returned links and articles. They would rather wait for an extra minute to get the right information than spend hours manually filter out the information through excessive irrelevant data. Being able to retrieve relevant information in a timely manner is the key to satisfy the user's need.
5. The Search Engine is a group of workhorses both work under text and graphic mode simultaneously, while the translation engine drives their directions. It relies on the massive partitioned, hashed indexes with heavy parallel processing power. Its data is collect by its crawler processes through DNS and hyper links.
   i. In text Mode:
      Its data structure still fits into current keyword search schema as of the dominant search engines today; but the processing side requires expand to “regular expression” search, which is initially pre-configured during installation, and gradually expanded by learning/feedback processes.
      The inventor use pre-configured ‘regular expression’ instead of classification technology which requires extensive dictionary lookup to determine subject/theme, in order to accelerate the search speed.
      E.g. if user asks: “What is RF?”, then after parsing and translation, the search engine will process each terms listed in the detail description section.
   ii. In graphic mode:
      We use Dynamic Spatial Relation (to search graphic objects after merge the result from search engine in graphic mode include video streams. In graphic mode, each scene is categorized into background and foreground. If in a video stream, the frame delta will be use to easy the separation of foreground from background. This technology was outlined by the inventor's previous patents, “Audio-Visual 3D Input/Output”, and each of the foreground object has control points in format of object (id, cpID, x,y,z, o[x,y,z], t), base on the basic information, the object and its properties or/and relationship to other objects can be identified and indexed for search engine by object name. If there are many objects, and spatial data index option will also used.
      With morph, affine, scale and rotation of an object built in the search capability, Euler angle rotation and NURBS calculation are used to pre-match a database model in order to save the time for the on-the-fly image search.
      As oppose to keyword search that the most dominant search engines (Google or Yahoo) use today, the inventor propose performing Conceptual search, so the information we returned has high relevance and ‘right to the target’.
6. The Inference Engine relays the task from the search engine, which provides relevant information related to the goal through conceptual search. The inference engine here mainly conduct propositional logic pass down from parser, such as ‘and’, ‘or’, ‘not’ with parentheses truth value determination. Some predicate calculus also provided in case user issue a complex query request. This inference engine uses predicate calculus, rules of inference and other form of logic deduction/induction to conduct reasoning and return documents with truth result back to user.

Overall, this disclosure try to take advantage of representing ‘existence’ at an abstraction level, because it is so basic that it can be used to cover almost every case in this category. Plus-utilize some of the single-and multi-dimensional index techniques commonly found in data warehouse (such as Teradata, Oracle) environments, with massive balanced data partitions and parallel processing power to return high relevant data in the shortest time frame.

### BRIEF DESCRIPTION OF THE DRAWINGS

1. FIG. 1 is the “System diagram for Multimedia Conceptual Search”. It depicts the relationship and workflow among the major components. Where voice recognition is optional. The database supports all the major engines to access data, concepts, facts and knowledge. The MD-BIOS is used to provide sensation and perception supported concepts.

2. FIG. 2 shows the field of invention is to computerize partial of the Epistemology and Ontology.

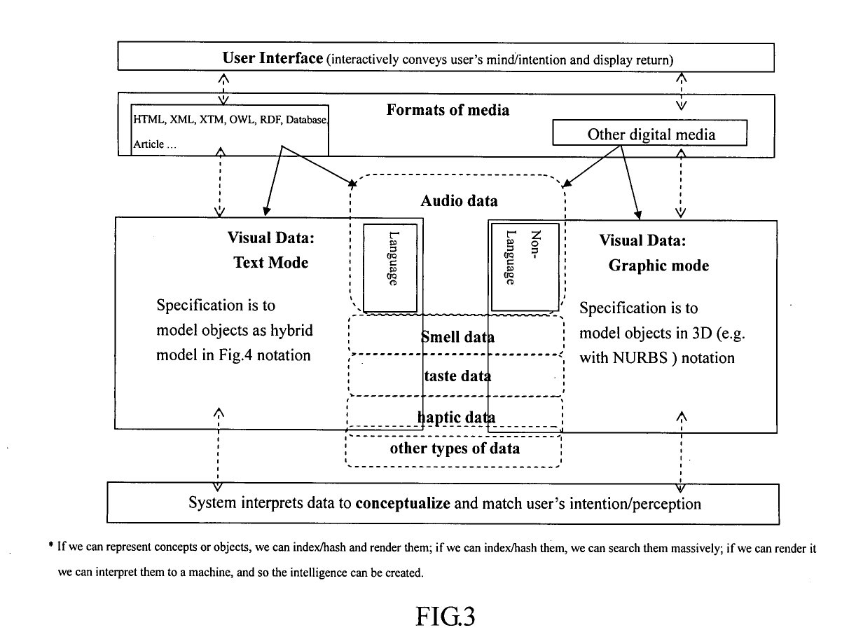

3. FIG. 3 is the approach of unifying all possible types of digit data. The system use many established ways of represents an ‘existence’ of a being as shown here.

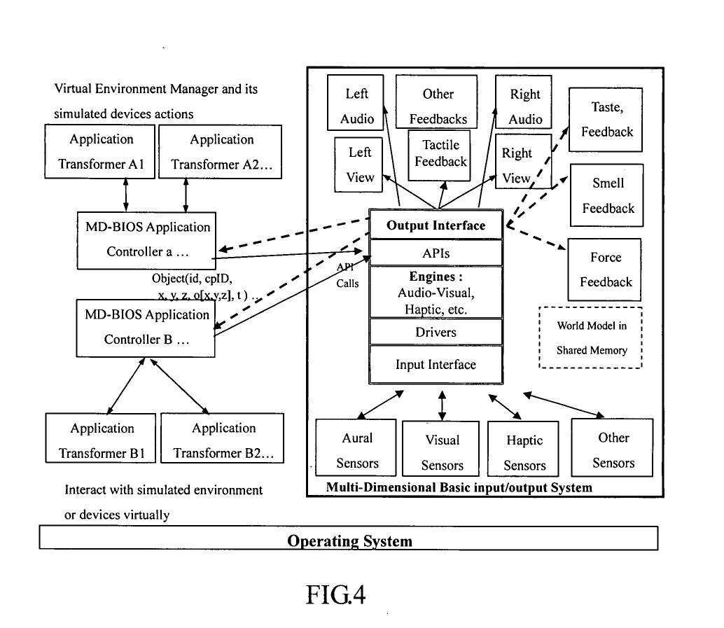

4. FIG. 4, the architecture of MD-BIOS, a sensor-centric (3D and beyond) data collection and autonomous system. Please see the inventor's previous U.S. application with Ser. No. 11/174,348, filed Jun. 30, 2005.

5. FIG. 5, Use Text as a database example to illustrate “Hybrid Architecture of ‘Multimedia Concept’ model”. It illustrates how the hierarchical, relational and network data models are created to accommodate the complexity of concept model.

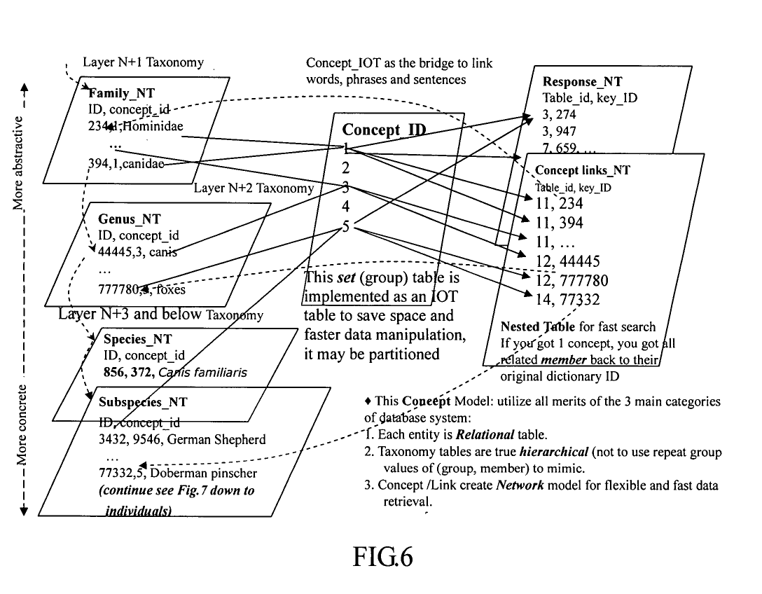

6. FIG. 6, Use Biological Taxonomy as an example for storing graphic object in database to illustrate “Hybrid Architecture of ‘Multimedia Concept’ model”. As you walk up the hierarchy, the concept becomes more abstractive (more basic to cover wilder) as oppose to walk down which become more concrete (eventually it covers only itself). Again the hybrid concept model still used for this way of representation. At the lowest bottom, the concept continues to drill down to FIG. 7.

7. FIG. 7 is a simplified visual example to explain the hybrid concept model (as oppose to previous database/link in text/graphic mode as shown by FIGS. 5 and 6). Note, that there are many types of links that are not strictly hierarchically, such as construction link and relationship link (which make them to be networked). Links of a node can skip levels, not all the links of a node link to the same level, one parent node has many links (may up to thousands in reality) and one child node may links to many parent nodes. Some link may have more weight than others.

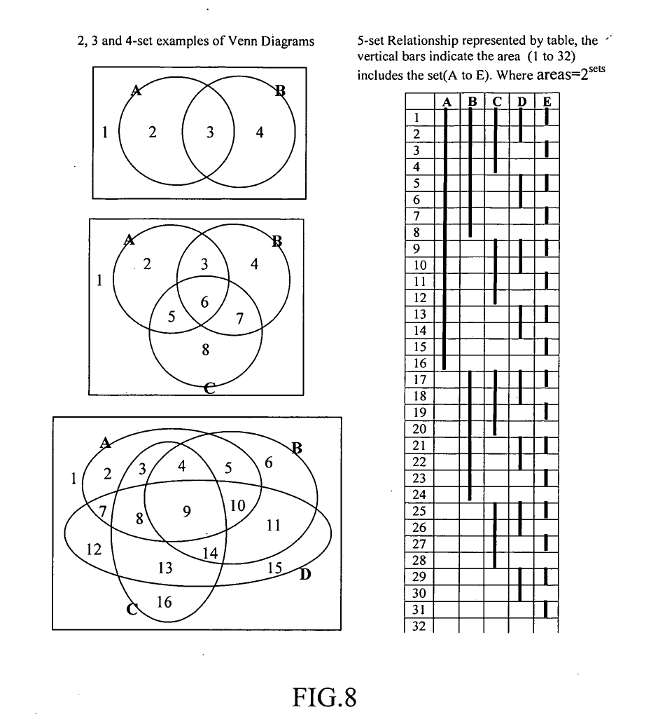

8. FIG. 8, The 5 set example for migrating from Venn Diagram into table notation for subset areas and “sets in higher order of Predicate logic”. The disclosure elevates the number of sets limitation and move set computation from qualitative to quantitative. This capability is an importance step to conduct predicate calculation for reasoning purpose.

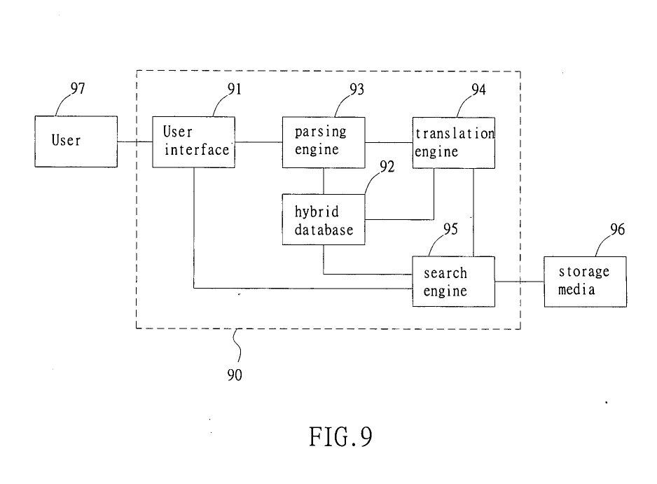

9. FIG. 9 is a block diagram showing the multimedia conceptual search system according to an embodiment of the present invention.

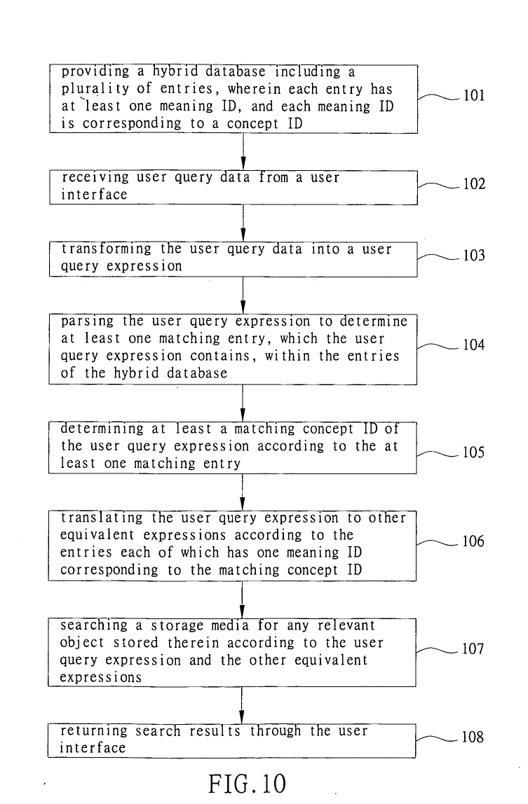

10. FIG. 10 is a flow chart showing the multimedia conceptual search method according to another embodiment of the present invention.

### DETAILED DESCRIPTION OF THE INVENTION

The current invention presents a method to represent real world objects either abstractive or concrete. The data instances are so immense that is outside the scope of present disclosure, instead, the author use examples to support and run through the presented method.

The significances of this invention are:
1. Advance in understand of how ‘concept’ is formed by using all available representations of multi-media sensory data (FIG. 1-4); our concept is not just cognize from text, natural language stand point (FIG. 5, 7), but also from graphic representation stand point (FIG. 6, 7). Both text and graphic modes are actually the further representation of human six sensations (eye/visual, ear/aural, nose/olfactory, tongue/taste, and body/tactile) and corresponding perceptions, they are being implemented both at concrete and at several of abstraction levels.
2. These sensations and perceptions are further processed by mimic human reasoning capability by way of first order logic, which are proposition and predicate logics, in order to fully utilize the information collected. Further can be done in a higher order of logic.
3. Search engine use the ‘Specification of Conceptualization’ of a subject to conduct concept-based search, instead of keyword search. The proposed technology can significantly increase the target information return and filter out unwanted content even if there are [keyword matched (false positive)] or there are [no keyword matched (false negative)] at all. This capability could change the landscape of today's Internet search and advertisement business.
4. Translation engine for better understanding between languages is based on the concept in a context select the right word and its belongings instead of word by word mapping between languages, which often becomes a barrier or even a joke when direct word to word mapping is used. (e.g. “FIG. 5” is translate to “the 5^{th} fig” in other language through the inventor's test in Internet, where the translated fig is the name in other language that means “the sweet, hollow, pear-shaped, multiple fruit”; and ‘go! go! go!’ from Mandarin is translated directly become ‘refuel’)
5. The Conceptual Search engine is a new breed of search engine that will further impact the multi-billion dollar market for future Internet search in the information age.
   The proposed method will become more significant because the transition from HTML to XML is already on the way and more and more videos are produced everyday.
      a. XML tag search, which provides true context-sensitive searching of XML documents require lots of the author's effort to identify and put tags in XML. Our method is to teach a machine and then let the machine do this effort to identify the concept between the lines.
      b. MPEG 7 (formally “Multimedia Content Description Interface”), which describing the multimedia content data that supports some degree of interpretation of the information, still-falls into the same limitation as XML tags which require tremendous human effort to describe them. By using our Audio-Visual 3D object tracking technology with the ‘specification of conceptualization’ capability, we can facilitate these types of searching task.
   The proposed method can ease the XML tag or MPEG 7 by pre-identifying the media content in context-sensitive (within a concept) style, and keep human intervention to its minimum. The concept that will be formed and stored in our object-relational database, the learned concept can be further networked into different field of knowledge.
6. Inference engine act as a human brain to conduct logic deduction and help to make a better response in term of relating concept, responding or planning tasks better. The execution of the response/plan may also provide feedback to make a better understanding or plan. This engine exposes many aspects of ‘blind points’ and corrects the fallacious reasoning made by humans. It can accelerate scientific study or investigations with less cost by avoiding mistakes.
7. By integrating the current proposed methodology and engines, the central processing unit of a ‘Thinking Machine’ can then be completed. It can be further integrated with IntelligenTek's sensing technology (such as our audio-visual remote sensing technologies). Automation of data collection from environment and existing document can be more efficient, which can greatly facilitate the data collection, trend analysis, data mining, prediction or enrichment with other structured data with fast result and less cost.
   A. Core Technology:

As in FIG. 3, there are many types of media has been represent in text mode and graphic mode, but they are represented in a lower raw data level instead at various higher abstraction levels (as demanded in FIG. 5, 6 and FIG. 7). The present disclosure migrates the raw data representation to a higher level of abstraction and builds interpreters on each type for abstraction level to endow machine with cognition ability. The representation of ‘existence of a being’ is carried out by:
1. Implement ‘Specification of Conceptualization’ (see FIG. 1, 7)
   Please note, Concept isn't necessary defined in natural language or dictionary, it can be defined as any ‘Formal Language’ which is unambiguous, such as scientific notation, symbolic logic, mathematic functions or any other formula which can be used to represent an existence of a being, process or event precisely.
   In this hybrid concept model (FIG. 5-7) knowledge of concepts can be hierarchically classified, related and networked. Before concept-based search can start its work, a basic language dictionary data for text processing is needed. This dictionary is major arranged according to the unique meanings of each word plus possible morpheme that could variate the meaning of the word. Indeed grammar is good entry point to categorize concept, but require supports from 1. text mode dictionary and 2. graphic mode model, plus 3. the hybrid database model. Typically, text model will work its way up from bottom of the database model to find the concept, while graphic will work its way down to locate the object.
   For examples concept about:
   A) Noun:
      To complete define a noun often require define both in textual and graphic modes. Noun phrase or clause is extensions of the basic noun by associating attributes/restrictions on it.
      A) Real object:
         a. Common noun: (a set with members) woman, singer, and etc.
         This type noun/set is an abstracted concept in the middle hierarchy of hybrid model as analogy to the model in FIG. 6.
         b. Concrete noun: an apple, fox, fish, and etc. This is a perfect example for graphic mode (FIG. 6) representation and interpretation.
         c. Mass noun: cannot be counted. Such as air, water The model requires many levels of definition, such as
            1. In phenomenon, appearance (of things): define how the 5 senses (aural, visual, smell, taste, tactile) many sense it and how our brain may perceive it. This helps the inventor's MD-BIOS (a sensor-centric Multi-Dimensional Basic Input/Output system see FIG. 4) to detect this type of mass noun. Please see the inventor's previous U.S. application with Ser. No. 11/174,348, filed Jun. 30, 2005.
            2. In science (noumenon, thing-in-itself): as H₂O, and many other chemical, physic formula, they help to define in more precise details as how it react to environment factors (temperature, pressure, acidity, . . . ). This definition helps MD-BIOS to predict the perceptions.
            In combine with fuzzy logic, this is a way to enable one on the most challenge daunting task of so call ‘Common Sense’.
      B) Abstract object:
         This type of noun requires using other words/concepts to define them as listed below.
         a. Philosophy:
            The branch of knowledge or academic study devoted to the systematic examination of basic concepts such as truth, existence, reality, causality, and freedom.
            A particular system of thought or doctrine.
         b. Tactics:
            The science of organizing and maneuvering forces in battle to achieve a limited or immediate aim.
            The art of finding and implementing means to achieve particular immediate or short-term aims.
         c. Happiness:
            feeling or showing pleasure, contentment, or joy.
            feeling satisfied that something is right or has been done right willing to do something.
            This relates to the state of mind, the lexicons (pleasure, contentment, or joy) themselves can't give machine an understanding, at most up to synonym level.
            The 2^{nd} explanation requires 2 concepts to explain ‘happiness’, one is ‘right’, the other is ‘satisfied’; while ‘right’itself has couple dozens of meanings, the ‘right’ here actually means ‘as expected’, but again ‘what is expected’? For the same event, if there are two competing parties, one will feel happy that other will not, because the expectation only happens in one of the parties; but again ‘what is satisfied’? This is also personal and need to define in a fuzzy way by perception (see next 3^{rd} paragraph for details).
            The traditional dictionary may not define concept vertically as layout in FIG. 7, often just provide synonyms, which is recursively reference each other, because synonyms themselves do not create a ‘concept node’ (FIG. 7), they just share one concept, without the underline support node, there isn't such a concept node exist. Synonym help for quick reference only when there is a true underline definition that is in a Well Formed Format (can trace down the element level in FIG. 7) to support upper nodes.
            The daunting task is first setup the concept nodes in the hybrid database in the correct way (as described above) to form such a relationship, tree and network nodes. The second step is to allow the hybrid model to self-learn and self-evolving to capture more concepts and hence more knowledge. From time to time, the concept node will need to go beyond vocabularies and dive directly into reference of the sensation data that MD-BIOS provided.
            Many of perceptions are not standard, including hearing (e.g. the HRFT (Head Related Transform Function) vary with individual). Recent findings in sensory neurobiology further confirm that vision, hearing and tactile perception are far more uniform across the species. But when it comes to odors and taste, one person's wine-of-the-gods can be another's plonk. This is because that human genome contains 347 olfactory genes (more variations); while there are only 4 (less variation) for vision. At least half of those genes are polymorphous, meaning that “they have a great potential of variation among themselves.
            So the machine/robot may as well setup as human to have individuality and personality when come to aesthetic standards. This way the user can use a search engine with his/her type of aesthetic standards in order to truly return the matched search result in this sub area of multimedia data.
      C) Proper noun: individual object usually capitalize. It is not just for human's name, it includes dogs too. The ultimate goal for representation and searching is going toward recognize individual in a subspecies.
      D) Pronoun: a noun that refers to previous mentioned individual or a group of individuals, it is the variable (as oppose to an instance) in natural language. This requires symbolic logic deduction as mention below in the predicate logic section, which is used to associate the properties to an object.
   B) Verb:
      Such as “Get, move, push, pop, run, stretch, smile, fear, flip, flop, and etc. . . . ”
      They require dynamic models of-moving direction such as NURBS vectors described below, the free-form model with vectors in a higher abstract level defines/represents these verbs. Other more complicate verbs can networks with basic/lower level verbs to form their definition. Such as ‘smile’ can be define as ‘stretch’ ‘mouth’ ‘upward’ (=verb+noun+adverb).
      After this conceptual modeling, then it can be implement by object identification and tracking as described in ‘Audio-Visual 3D I/O’ patent (Filed on Jul. 24, 2004). Where we identify a ‘month’ by “face recognition” process, track its movement over the time to determine whether it has ‘stretched’ (as defined in the conceptual model previously that length has elongate over the time e.g. Lₜ₂>Lₜ₁ for video stream, or fuzzily define lip edges are pointing toward eyes for still image), if it did, then check the curves at each end are point upward to the eyes instead of chin. Whether the mouth is open or shut isn't our concern in term of interpret whether someone is smiling or not from video stream.
      Again each concept can be represented in very detail include various level of abstractions, once the basics are defined, many higher level concepts can just harness on top of them as described above and in hybrid data model, much like many markup languages did in today's Internet (e.g. VRML).
      Verbs are special, because it involves with command for machine interface. For example, a human can just issue a command (=concept of goal) in the form of natural language (typical a verb phrase, sometimes a sentence), the machine can traverse down its components sub tree (similar to a bill of materials of concepts) autonomously with minimum of human intervention.
   C) Adjective:
      “Beautiful, ugly, long, short, big, small, hot, cold, red, blue, bright, dark, delicious, stinky, fast, slow” are all degree related evaluation.
      Many evaluation of using adjectives are perception related without absolute standard as mentioned above in the mental status of ‘Happiness’. Adjectives often requires relativity in fuzzy logic way.
   D) Adverb:
      Fast, slowly, shortly, hard, hardly.
      It inherits many characters as adjectives except they work on verb.

All of above noun, verb, adjective, and adverb can also appear in the form of a phrase or clause. And will from time to time involve with the 6 senses that MD-BIOS collected and represented.

We further use a complicate word ‘matter’ to show how the bottom-up textual search identify the concept from the limited input data-word, phrases, sentences. And we further put another exemplar word ‘push’ into the hybrid database.
E) Example word ‘matter’:
   The word shows the demand of hybrid model because its complexity of locating a unique concept (see CTs in FIG. 7), regular expression is used here:
   I. n. (slant Parentheses is the inventor's annotation, here the noun is sorted by grammar belonging)
      Something that occupies space and can be perceived by one or more senses;
      a physical body,
      a physical substance, or
      the universe as a whole.
      1) Physics: (‘[Terminology]’ indicate meaning of specific subject) Something that has mass and exists as a solid, liquid, or gas.
      2) A specific type of substance
         [Adj. /P] matter. ([Adj. IP]=express for Adjective/Phrase, e.g. inorganic)
      3) Discharge or waste, such as pus or feces, from a living organism.
      4) [Philosophy]:
         In Aristotelian and Scholastic use, that which is in itself undifferentiated and formless and which, as the subject of change and development, receives form and becomes substance and experience.
      5) [Christian Science]:
         That which is postulated by the mortal mind, regarded as illusion and as the opposite of substance or God:
         “Spirit is the real and eternal; matter is the unreal and temporal” (Mary Baker Eddy)
      6) The substance of thought or expression as opposed to the manner in which it is stated or conveyed.
      7) A subject of concern, feeling, or action:
         matters of [NP] ([NP], e.g. foreign policy)
         [Adj. /P] matter. ([Adj./P, e.g. a personal]
         See: subject (underline is a link to jump to other place)
      8) Trouble or difficulty:
         What's the matter with [NP]?
            ([NP]=express for Noun Phrase, e.g. [your car],
         [your sister])
      9) An approximated quantity, amount, or extent:
         [SP] will last a matter of years. ([S/P]=subject/phrase, e.g. [The construction])
      10) Something printed or otherwise set down in writing reading matter.
      11) Something sent by mail.
      12) Printing
      13) Composed type.
      14) Material to be set in type.
   II. v.intr. (verb, intransitive)
      mat.tered; mat.ter.ing; mat.ters;
      (morpheme of -ed for past tense, -ing for Present Participle, and -s for its plural form)
      1) To be of importance:
         “Love is most nearly itself/When here and now cease to matter” (T. S. Eliot) See: count
   III. Idiom (system will match each word in exact order of the expression)
      1) “as a matter of fact”
         In fact; actually.
      2) “for that matter”
         So far as that is concerned; as for that.
      3) “no matter” [interrogatives adverb]
         Regardless of:
         “Yet there isn't a train I wouldn't take,/No matter where it's going” (Edna St. Vincent Millay)
   IV. Origination
      1) Middle English
      2) From Old French matere
      3) From Latin m³teria
F) Put the exemplar word ‘push’ into the hybrid database:
   I. Text mode concept model (see FIG. 5 and FIG. 7):
      Because the system works on natural language, Vocabulary is the foundation to form concepts from user's input. The system at its beginning is infused with dictionaries, later it will grow just like kids starting to learn new vocabularies during their development. We use SVM (Support Vector Machine) approach to endow the system with learning capability.
      Text is the visual representation for most parts of voice in human natural language, for over past thousand years, human has done a good job in this type of text information on various media (e.g. turtle shell, bamboo, stone, cloth, paper, and magnetic/digital media), and since it is well represented, index and hashing techniques are also well developed to conduct massive search at keyword level. The present disclosure use method outlined in figures to migrate this type of keyword search into concept-based search.
      Below is an example of object-relational database structure to host a word. Note, many “types” and “IDs” here will be converted to number/ID instead of an English term; this is only for illustration purpose.

At highest object level of word: it is a heap table English_Dictionary with database constraints

| ID | Word | Concept ID | . . . |
|---|---|---|---|
| 1234 | Push | 23415 | |
| 3245 | pop | | |

Not all the words at all level has its immediate concept links, due to the complexity of the word, which requires more modifier in order to truly spot its concept, but the lowest level dictionary table always has a concept ID to point to. The concept_IOT (Index,Organized Table) table acts as a bridge to link all the related term together. In logic term, each entry in the concept_IOT table is a set, and each entry in the nested table is member of the set. And each entry in the nested table is member of the set. See the following pseudo-SQL code for details.

-- Create nested table for the IOT table concept_iot field links
create or replace type concept_type as object (

id Number,
. . .

);
create or replace type concept_links as table of concept_type
;
/* Concept (id) table is universal among different languages, though the
inventor uses English to describe it */
create table concept_iot ( /*an index organized table*/

| | |
|---|---|
| id | number, |

| -- the nested table links all possible different ways of express same | |
|---|---|
| concept concept_links_NT | concept_links, |

| | |
|---|---|
| Description | varchar2(4096), |

| -- 1 concept has many different ways of response, we don't | |
|---|---|
| select best response in phase I | |
| Response_NT | concept_links, |
| . . . | |

constraint concept_iot_pk PRIMARY KEY (ID )

)
organization index
nested table links store as links_nt ;
-- Create nested table for the IOT table concept_iot field links
create or replace type grammar_sub_type as object (

| | |
|---|---|
| id | Number, |

| | |
|---|---|
| concept_id | references concept_iot, |
| . . . | |

);
create or replace type grammar_sub_types as table of
grammar_sub_type
;
-- Create nested table for the IOT table concept_iot field links
create or replace type grammar_type as object (

| | |
|---|---|
| id | Number, |

| | |
|---|---|
| concept_id | references concept_iot, |
| grammar_sub_type_NT | grammar_sub_types, |
| . . . | |

);
create or replace type grammar_types as table of grammar_type
;
--you may further create partitions to push performance and easy
--storage management.
CREATE TABLE English_Dictionary (

| | |
|---|---|
| Id | number Primary Key, |
| Word | varchar2(64) Not Null, |

--and so on for columns ...

| | |
|---|---|
| concept_id | references concept_iot, |

| grammar_type_NT grammar_types,/* create 2^{nd} level of | |
|---|---|
| nested table*/ | |
| Phrase _NT | grammar_types, |

| | |
|---|---|
| Idiom_NT | grammar_types, |
| Slang_NT | grammar_types, |
| ... | |

```
constraint English_Dictionary_PK PRIMARY KEY (ID )
      Using index Tablespace ts_Eng_dict_idx,
constraint English_Dictionary_UK UNIQUE KEY ( Word )
      Using index  Tablespace ts_Eng_dict_idx,
...
```

);

In FIG. 5, we use a hybrid database system model to depict how the atom/finest dictionary definition is setup to be in relational, hierarchical and network by way of IOT table, Nested tables (hierarchical) and Heap tables (relational) with links (network) to form an dynamic, flexible data model (structural) with deliberate data (values) design. Please note, this type of hybrid model typical suffer from performance issue when compared with flat relational model in a very large database system (VLDB).

The 2nd level Nested Table Grammar type_NT_in dictionary hierarchy:

| | | | | |
|---|---|---|---|---|
| | Sub grammar | | | |
| Grammar_type_NT | word type | meaning | . . . | Concept ID |

Verb
Noun

The 3^{rd} level table Sub_grammar type_NT in dictionary hierarchy:

| | Past | | | | | Concept |
|---|---|---|---|---|---|---|
| Sub_grammar_type | tense | Present_participle | plural | meaning | . . . | ID |
| tr | .ed | .ing | .es | | | |
| intr | | | | | | |

Then it comes back the 2^{nd} level Nested Table Phrase_NT in dictionary hierarchy:

| | | | |
|---|---|---|---|
| Phrase | meaning | . . . | Concept ID |

Push around
push off
push on

The 2^{nd} level table Idiom_NT in dictionary hierarchy:

| | | | |
|---|---|---|---|
| Idiom | meaning | . . . | Concept ID |

Push paper

The 2^{nd} level table Slang_NT in dictionary hierarchy:

| | | | |
|---|---|---|---|
| Slang | meaning | . . . | Concept ID |

push drugs

And so on . . .
Create ‘conceptual links’ (see FIG. 5) among words, which is usually the first clue of finding related words to form a concept from user's input or query. The conceptual links can be either network or hierarchical related to form a stream of concept. The link in the database is simply an ID field that represents a concept.
By score the grammar parsed meanings from user's input, and transverse the hybrid nodes bottom-up (see FIG. 7), we can find the appropriate concept taxonomy during our way up in the concept tree/networks. If there are ambiguities, the search engine will ask user to further narrow the searching concept, if user's preference is setup to do so in interactive mode.
II. Graphic mode concept model (see FIG. 6 and FIG. 7):
Shape, chroma, texture/pattern are our primary concerns in graphic representation.
1) Basic morphological data representation method:
The candidate of representation basic visual element has to be universal so it covers all regular geometrical and free-form shape in 3D, and it has to be invariant under affine or perspective transformation, because object under tracking could be at any view angle.
A NURBS (Non-Uniform Rational B-spline) curve C(t) is defined by knot vector value t and n control points P₀ . . . Pₙ with degree of d (from 0 up to the highest power D of all terms in the polynomial function):

$$C ( t ) = \frac{{\sum }_{i = 0}^{n} {N}_{i} , d ( t ) * {W}_{i} * {P}_{i}}{{\sum }_{i = 0}^{n} {N}_{i} , d ( t ) * {W}_{i}} \qquad NF ( 1 )$$
The entire curve has n+1 pieces of curves, i is the ith piece of curve start from 0.
Where t is a parameter along knot vector (see Kv below),
and Nᵢ,d(t) are Normalized B-spline Basis functions of degree d, see formula Nᵢ,d(t) below.
and Pᵢ is the ith control point (vector),
and Wᵢ is the weight of Pᵢ the last ordinate of the homogeneous point Pᵢ^{w}.
These curves are closed under perspective transformations and can represent conic sections exactly.
Furthermore, A B-spline is a generalization of the Bézier curve. Let a vector known as the knot vector has m(=n+D−1) knots (older algorithm use m=n+D+1) can be defined as:
   Kv={k₀, k₁, . . . , kₘ}
where Kv is a non-decreasing sequence with kᵢ∈[0,1], and the Basis functions of B-splines are defined recursively from d to 0 as

$$\begin{matrix}{N}_{i} , 0 ( t ) = \begin{matrix}1 , & if {k}_{i} <= {k}_{i + 1} , and {k}_{i} < {k}_{i + 1} \\ 0 , & else\end{matrix} & NF ( 2 ) \\ {N}_{i} , d ( t ) = \frac{t - {k}_{i}}{{k}_{i + d} - {k}_{i}} * {N}_{i} , d - 1 ( t ) + \frac{{k}_{i + d + 1} - t}{{k}_{i + d + 1} - {k}_{i + 1}} * {N}_{i + 1} , d - 1 ( t ) & NF ( 3 )\end{matrix}$$
2) Basic chrominance data representation method:
   The candidate for representing chrominance has to be stable in its value under various lighting conditions. By selecting UV chroma of xYUV format (eg. iYUV, YUV) we can get pretty stable value under not extreme bright or dark condition according to the HLS (Hue Lightness Saturation) Model; unlike RGB model the color values are combined with light intensity, so its color information changed as lighting condition changed, chroma UV is much precise and less sensitive to lighting condition.
3) Texture/Pattern:
   Texture is the combination of repetition of shape and color.
4) Feature extraction:
   Control points in NURBS notation are selected whenever there is sharper turn in moving direction of a curve (includes a straight line). 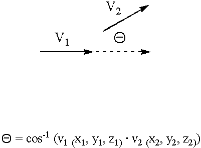
   Where · is the inner (or scalar) product; the z1 or z2 can be ignored if it is 2D. The determination of (⊖>threshold) will greatly impact the amount of data collection with trade off to accuracy.
5) Model construction and matching:
   Two or more pictures of the same object are required for construct 3D model of an object. Assume the 2 pictures are from identical object but from different angle of perspective views with know. The process of constructing a 3D model is done by:
   a) outline object by edge detection: E.g. The following 3-picture set are under controlled, in term of equal distance and perspective panning angle. This type of setup needn't spend as much effort as the free-from model (see example b).).
   b) Use one of the better (more clear) view as reference, and perform the following operation on the control points of other view to match the reference.
      i. scale
      ii. tilt
      iii. panning
      iv. rotation
   These 4 operations can be found in the inventor's previous U.S. application with Ser. No. 11/174,348, filed Jun. 30, 2005.
   If target is for human face recognition, additional 2 types of operation can be applied:
      i. Eyes and lips morph vertically.
      ii Age progressing morphic effect.
   e.g. The following 3 picture set are of different perspectives in term of view angle and distance. So that all above 4 operations (scale, tilt, panning, and rotation) are needed.
6) Match target object in database:
   Almost every object is subject to perspective transformation, because the angle and distance vary between observers. Plus some of the objects (such as swimming fishes) may warp their bodies, they are potential affected under affine, rotation and warp.
   Project outline from 3D model to 2D image/view work only on the control points defined above, moreover the NURBS is invariant under affine or perspective transformation, so this is a fairly fast transformation process. Score are used to for degree of match based on shape transformation, size and chroma if any.

The target image/s searching process can be divided into 4 scenarios as shown in Table 1 below:

TABLE 1
Graphic mode object matching scenarios

| Searched | Input target | |
|---|---|---|
| Database | 2D image/s | 3D Model |
| 2D images | Not all the images can form | As long as 3D model for input can be |
| | 3D model, if they are not | constructed, search is more flexible |
| | complementary. | and faster. |
| | This is the worst case among | Because database image are pre- |
| | the 4 scenarios. It require very | processed. View angle and |
| | similar view angle between | perspective distance are known when |
| | matching target image and | perform 2D database images search. |
| | matched database 2D images. | The target 3D model will be projected |
| | Some minor warping can be | using the perspective factors from |
| | applied to enhance the match score. | database 2D image, and then compare |
| | | the projected view with the 2D |
| | | database image. |
| 3D Models | Requires to evaluate view | This is the best scenario we have, |
| | angle and distance of target | what we need is directly compare |
| | 2D image first (Extrapolate | Require 2 good complementary, |
| | the occult portion of view | partial overlapped front views to |
| | leave us into the probability | construct 3D input model, a 3D input |
| | world). Use them to get the | model when under morphic operation |
| | projected 3D to 2D | can provide more flexibility and |
| | perspective view, and then | accuracy during search. |
| | compare with the target 2D | |
| | image. This is a quick way to | |
| | find its match without full | |
| | morph. | |

After the scenario is determined, the graphic mode search engine will walk down the Multimedia concept model (FIG. 6) to further narrow down the searching area and eventual spot the individual entities in the database.
7) Index for fast matching:
   Unlike text where we have a mean to hash a text value to immediately access the object location by hash value, graphic value is more complicate.
   a) Basic shape search:
      Require to score the matched shape by control points along the NURBS curve.
   b) Feature search:
      Graphic mode index is done by Spatial Index technique of features/parts.
      The goal for NURBS curve/shape is for identifying features or parts of an object, once the part and feature is figured out, we no longer require NURBS for search purpose.
G) Put the exemplar animal taxonomy into the hybrid database (see FIG. 6 and FIG. 7):
   By score the features extracted from graphic objects either from user's input or automatic collected from sensors, and match the objects between input and database models by transverse the hybrid nodes Top-down (see FIG. 7), we can find the appropriate object and its behaviour (by using concept taxonomy CTs in FIG. 7) during our way up in the concept tree/networks. If there are ambiguities, the search engine will ask user to further narrow the searching concept, if user's preference is setup to do so in interactive mode.
2. Implement Conceptual ‘Parsing Engine’(see FIG. 1)
   Develop the Concept Parsing Engine on the top of some free-domain, open source English parsing engines, to facilitate text mode of concept-based and content-based searching requirement. Parser does not require you to embed your grammar directly into your source code. Instead, the Builder analyzes the grammar description and saves the parse tables to a separate file. This file can be subsequently loaded by the actual parser engine and used.

We start by testing English grammar rules to parse the sentence or phrase, ‘interrogative words’ as the first set of examples for searching purpose. They are What, Why, How, When, Who, Where, etc., we start identify the belongingness of the words, which enable us to correctly extract the true meaning that a word plays in a phrase or sentence. Once the true meaning among many meanings that a word can represent is located, the ‘conceptual links’ start to kick in. The parse engine uses the same rules/techniques as modern programming language compiler, except it works on Natural Language. Sample testing English grammar rules as listed in Table 1 below to parse the sentence or phrase, identify the belongingness of the words:

TABLE 2
Sample English Grammar Parsing rules

| Expression | Example | Meaning |
|---|---|---|
| sentence --> np, vp. | | we sentence is either an noun phrase then a verb |
| | | phrase |
| np --> pn. | | a noun phrase can be end with a proper noun or |
| np --> d, n, rel. | | a noun phrase is a determiner with a noun and a |
| | | relative clause |
| vp --> tv, np. | | a verb phrase is a transitive verb followed by a noun |
| | | phrase or |
| vp --> iv. | | a verb phrase is an intransitive verb. //and so on . . . |
| | | you got the idea. |
| rel --> [ ]. | | relative clause |
| rel --> rpn, vp. | | |
| pn --> [PN], | pn(mary) | proper noun, you can macth the word ‘mary’ in our |
| {pn(PN)}. | pn(henry) | dictionary structure as a proper noun so does match |
| | | ‘henry’, and so on . . . |
| rpn --> [RPN], | rpn(that) | relative pronoun |
| {rpn(RPN)}. | rpn(which) | |
| | rpn(who) | |
| iv --> [IV], | iv(runs) | intransitive verb |
| {iv(IV)}. | iv(sits) | |
| d --> [DET], | d(a) | determiner |
| {d(DET)}. | d(the) | |
| n --> [N], | n(book) | noun |
| {n(N)}. | n(girl) | |
| | n(boy) | |
| tv --> [TV], | tv(gives) | Transitive verb |
| {tv(TV)}. | tv(reads) | |

Enable us to correctly extract the true meaning that a word plays in a sentence. Once the true meaning among many meanings that a word can represent is located, the ‘conceptual links’ start to kick in. The parse engine uses the same rules/techniques as modern programming language compiler, except it works on Natural Language. Below are some examples of grammar structure that we'll write matching functions to identify tokens from top down. This is also a typical symbolic logic (a recursive hypothetical syllogism) calculation for
   (p″q) and (q→r) therefore(p→r)
3. Technology for Conceptual ‘Translation engine’ (see FIG. 1)
   A) For search engine: Once parsing engine identify the belongingness of words, the translation engine will transverse the parsed tree to collect ‘words’, ‘phrases’ or ‘sentences’ setup in the database as members of the concept set. Note, the words in a ‘phrases’ or ‘sentences’ has to be in exact order for the regular expression search engine to execute. Depending on the need it can output either the symbolic logic expression for inference engine or (‘words’, ‘phrases’ or ‘sentences’) regular expression for search engine.
   B) For inference engine: Besides basic logic understanding pass down from parser, the Translation engine also converts predicate (word depicts relationships) English into expressions in Symbolic Logic. Inference engine works with searching during and after search to return more robust results to users.

Table 3 below is an exemplar term for translation from English to Symbol, more complete list will be installed in database:

TABLE 3
Example for translation in Predicate Logic

| | | |
|---|---|---|
| English | Translation | Meaning |

(p, q are propositions, and logic operators are expressed in C/C++ language style)

| | | |
|---|---|---|
| And/or | \| | \| = or, convert ‘and’ to “or” if in |
| | | conversation, colloquial |
| And | & | & = and |
| | | If in ‘CONDITION’s |
| Neither, nor. | “˜p & ˜q” or | ˜ = not |
| | “˜(p \| q)”. | |
| Not both | “˜(p & q)”. | |
| both not | “˜p & ˜q”. | |
| “No A is B” “A isn't B” | A ∩ B = Ø | Set A intersect set B is |
| “There isn't A of B” | | empty set Ø |
| “There isn't common of A and B” | B ⊂ A̅ | Set B belongs to non-A |
| “Some of A are B” | A ∩ B ≠ Ø | A intersect B isn't an empty set |
| “There are A of B” | A ∩ B = ε | Or their intersect exists members |
| “Some of A aren't B” | | |
| “At least some A aren't B” | A ∩ B̅ ≠ Ø | |
| “At least some A belong to non-B” | A − B ≠ Ø | |
| “it isn't true that every A is B” | | |
| “if p, then q”, “if p, q”, | ( p → q ) or | → in proposition logic |
| “p implies q”, “p entails q”, | | |
| “p therefore q”, “p hence q”, | | |
| “q if p”, “q provided p”, | | |
| “q follows from p”, | | |
| “p is the sufficient condition of q”, | | |
| “q is the necessary condition of p”. | | |
| ======same meaning ====== | | ⊂ In predicate logic |
| “all the A is B” | ( A ⊂ B ) | Usual express p as A set and q as |
| “if it is A then it is B” | | B set |
| “only B is A” | | |
| “every/any A is B” | | |
| p only if q | ( p [symbol] q ) | |
| If and only if | ( p [symbol] q ) | |
| “P even if q” | “p & (q \| ˜q)”. | |
| “p whether or not q” | | |
| “p regardless of q”. | | |
| . . . | | |

| | |
|---|---|
| **E.g. ‘think (of), still, exact(ly), | ** these vocabularies can't be translate into |
| absolute(ly), believe, know, maybe, | symbols, they are non-extensional, epistemic |
| etc . . . | or modal, because they make no difference |
| | to the expression |

Be aware to rewrite the colloquial conversation to be a well formed sentence, such as:
“A or B will go to city C and D to find a job”
Should be rewrite to “A go to city C or A go to city D or B go to city C or B go to city D”. note that the ‘and’ is actually translate to logic ‘or’, because normally a person live in a city with a job at one time.
4. Technology of ‘Conceptual Inference Engine’ (see FIG. 1)
   The inference engine has two levels of logic deduction while works with search engine during and after search. During searching and after returning the addresses of found pages and articles, which might contains duplicated facts, the inference engine may use inference rules in propositional logic with predicate logic to reach its goal by the following sequence:
   A) Proposition logic deduction:
      This is more independent portion compare with predicate logic portion, because the proposition are much simpler and well developed than predicate logic, while predicate logic rely more on understand the concept plus relationship links after parsing and translation in order to correctly assign a concept to a set, understand their attributes and specify the correct relationship between multiple sets.

The Propositional logic inference rules are listed below, these rules are just data to our rule based Inference engine, which in turn use concept abstraction, parsing engine, translation engine before using the rules list below. Once it reach the stage of being ready to use these inference rules, the inference engine simply conduct symbol matching algorithm onto the symbols in the rules to transform to symbols. The inference rules are listed below in Table 4.

TABLE 4
List of Rules of Propositional Logic

| | Propositional Logic expression |
|---|---|
| Name of Rule | (see notation in Table 3) |
| Modus ponens | [(p → q) & p] → q if [(if p then q) and p] then q |
| Modus tollens | [(p → q) & ˜q] → ˜p if[(if p then q) and not q] then not p |
| Conjunction | [(p) & (q)] → [p & q] if p and q are true individually, |
| introduction | then p and q as a group also true |
| (or Conjunction) | |
| Disjunction | [p] → [p \| q] if p is true, then (p or q) is true |
| introduction | |
| (or Addition) | |
| Simplification | [p & q] → [p] if (p and q) group is true, then p is true |
| Disjunctive syllogism | [(p \| q) & ˜p] → [q] if (p or q) and not p] is true, |
| | then q is true |
| Hypothetical syllogism | [(p → q) & (q → r)] -> [p → r] |
| | If [(p then q) and (if q then r)] true, then we can say [if p true then r true] |
| Constructive dilemma | [(p → q) & (r → s) & (p → r)] → [q \| s] |
| Destructive dilemma | [(p → q) & (r → s) & (˜q \| ˜s)] → [˜p \| ˜r] |
| Absorption | [p → q] -> [p → (p & q)] |
| Composition | [(p → q) & (p → r)] -> [p → (q & r)] |
| Double negative | [˜ ˜ p] [symbol] [p] if and only if [not not p] is true, then p is |
| elimination | true (and vice versa) |
| Material Implication | [p -> q] [symbol] [˜ p \| q] |
| Material Equivalence | [p [symbol] q] [symbol] [( p -> q) & (q -> p)] |
| | [p [symbol] q] [symbol] [(p & q) \| (˜p & ˜q)] |
| | definition of “if and only if [symbol] ” in details |
| Transposition (or | [p -> q] [symbol] [˜q -> ˜p )] |
| Contraposition) | |
| Importation and | [p -> (q -> r)] [symbol] [ (p & q) -> r ] |
| Exportation | |
| Distribution | [p & (q \| r )] [symbol] [ ( p & q) \| ( p & r ) ] |
| | [p \| ( q & r )] [symbol] [ ( p \| q ) & ( p \| r ) ] |
| De Morgan's Laws | [˜(p \| q)] [symbol] [ ˜p & ˜q] |
| | [˜(p & q)] [symbol] [ ˜p \| ˜q] |
| Commutation | [p \| q] [symbol] [ q \| p] |
| | [p & q] [symbol] [ q & p] |
| Association | [p \| ( q \| r)] [symbol] [(p \| q)\|r] |
| | [p & ( q & r)] [symbol] [(p & q)\|r] |
| Tautology | [p] [symbol] [p \| p] |

B) Predicate logic deduction:
   See Parsing and the hybrid architecture in FIG. 1, where when parsing reduces words into concept ID (a set), then all of its members can be found through concept links table to extract “serialized keyword” entries for regular expression based search engine. The example listed below process members of sets based on predicate logic theory initially developed by inventor back into 1984. It is the first quantification method that surpass Venn Diagram qualification processing, see FIG. 8 for the first 3 Venn Diagrams (up to 4 sets) that migrates to Lin's Table with 5 sets example, 7 sets and beyond follows the same principle.
   Predicate logic can further help user do the final analysis by:
   1. Make facts found by search engine unique, then
   2. Collected facts/situation as premises of an argument,
   3. Reuse the parsed result and call translation engine to return expression in symbolic logic for each premise.
   4. Check the consistency among premises.

5. Use the key concept that each logic operator is actually a function of confirm or deny certain areas (=subsets created by intersection) generated by intersecting of entire logic sets. p2 Predicate Logic deduction Rules developed by current inventor:

TABLE 5
List of Rules of the inventor's Predicate Logic

| | Area Operation | |
|---|---|---|
| | (=subset, represented by number, see FIG. 8) | |
| | If one subset appears at both side, the subset | |
| Operator | should be eliminate first. | Meaning |
| = | Because only Ø = Ø, | Where mx ≠ ny |
| | If Σm = Σn then | Because every subset represent different |
| | m1 = Ø, m2 = Ø . . . and n1 = Ø, n2 = Ø . . . | sets intersection (hence different |
| | (if operate on sets, they need to be break | meaning), if you try to make they equal, |
| | down to subset areas as shown in FIG. 8) | the only way is to make them an empty |
| | | set. |
| | If Σm = Ø then | Comma ‘,’ to denote and ‘\hat{ }’ |
| | m1 = Ø, m2 = Ø . . . , mn = Ø | |
| | Special case of ≠ | v to denote inclusive ‘or’, there can be one |
| | If Σm ≠ Ø or Σm = ε then | of the C(m, n) combinations |
| | m1 = ε v m2 = ε . . . mn = ε | |
| ⊂ | because Ø ⊂Ø or Ø ⊂ ε | Only empty set belong or equal to another |
| | if Σm ⊂ Σn then | set |
| | left side m1 = Ø, m2 = Ø . . . mn = Ø, but right | |
| | side areas are unknown. | |
| ⊂ | because Ø ⊂ ε | left side use comma to denote and \hat{ }. |
| | if Σm ⊂ Σn then | right side can be one of the C(m, n) |
| | left side m1 = Ø, m2 = Ø . . . mn = Ø, | combinations (they are inclusive or). |
| | right side n1 = ε v n2 = ε v . . . nn = ε | |
| ≠ | Because Ø ≠ ε or ε ≠ Ø or ε ≠ ε | Eg. see FIG. 8, the 2-set example A, B |
| | If Σm ≠ Σn then after eliminate subsets that | If A ≠ B then 2, 3 ≠3, 4 so other than |
| | appear in both side, other than the following | [2Ø, 4Ø], any combination is possible, |
| | skip conditions { m1 = Ø, m2 = Ø . . . and | such as [2Ø, 4ε] or [2ε, 4Ø] or [2ε, 4ε] |
| | n1 = Ø, n2 = Ø . . . nn = Ø }anything | |
| | else could be possible. | |
| others | ⊃ ⊃ | Same as the counterparts, just reverse of |
| | | operation direction. |

Here are some exemplar principles,
   e.g.: set A⊂B can be expressed as A−B=0 too, where 0 is a null set. So there are 4 areas (subsets) as you can easy imagine from Venn Diagram, the inventor's invention is to explore this basic rule and let computer process unlimited number of sets. By knowing what the ⊂ or-sign implied, we know area 2 is a null subset. These basic rules about logic operators that either reduce each subset to three values: exist, empty and unknown through confirmation or elimination can be propagated to be very sophisticate predicate calculus and resolve argument validation problems.
It may vote the inconsistent premises out through its learning (neuro-network based) experience, or ask consultation from human only if needed Oust like us).
Process the passed conclusion, judgment or hypothesis from user after they conduct research and then validate the argument. Or simply show all the details found by the inference engine to the user.

### EXAMPLE 1

### For 3 Sets Inconsistent Premises

ex. (c) If god is omniscient and almighty, can he create a stone
which he is unable to move ?
Parse the paragraph into the following 3 sentences:
(where Ø is ‘empty set’, x is ‘exist’, ˜is ‘not’ and & is ‘intersect’, Ω is the inclusive or of Cₘⁿ
combinations)

| | |
|---|---|
| Expression | Natural Language |
| ˜A=o | 1) God is omniscient and almighty |
| A&C=o | 2) God is omniscient and almighty so he can move everything |
| B&C=x 3) | God can create a stone that he can not move |
| Where : | A = omniscient and almighty |
| | B = create a stone |
| | C = he is unable to move it |

```
*-*-*-*  CONTENT OF LIN TABLE OF THIS PROPOSITION *-*-*-*
  A => 0  1  2  3
  B => 0  1  4  5
  C => 0  2  4  6
******  Begin test infix to postfix and evaluate ******
```

| | |
|---|---|
| ˜A=0 | 1) God is omniscient and almighty |

---------- evaluating sequence ----------

| | | | | |
|---|---|---|---|---|
| 4 | 5 | 6 | 7 | |
| 4Ø | 5Ø | 6Ø | 7Ø | //confirm that subset 4,5,6,7 are null sets |

| | |
|---|---|
| A&C=o | 2) God is omniscient and almighty so he can move |

---------- evaluating sequence ----------

| | | |
|---|---|---|
| 0 | 2 | |
| 0Ø | 2Ø | //confirm that intersects of A and C are null set |

| | |
|---|---|
| B&C=x | 3) God can create a stone that he can not move |

---------- evaluating sequence ----------

| | |
|---|---|
| 0 | 4 |

| | |
|---|---|
| 0x Ω 4x | //confirm that intersects of B and C are has members |

*********** RESULT OF THE LOGIC CALCULATION ***********
===== Normal part of Premises =====

| | | | | |
|---|---|---|---|---|
| 1. | 4Ø | 5Ø | 6Ø | 7Ø |

| | | | |
|---|---|---|---|
| 2. | 0Ø | 2Ø | //premises 1 and 2 said subset 0 and 4 are nulls, |

----- Or-connect part of Premises -----

| | |
|---|---|
| 3. 0x Ω 4x | //but premise 3 said subset 0 and 4 exist. |

Inconsistency in premise 3 which has or-connect, premise 1 and 2
conflict with premise 3.

### EXAMPLE 2

### For 5 Sets Argument Validation

An ecologist who investigated some kinds of animals in some area got
the following data:
(where Ø is ‘empty set’, x is ‘exist’, ˜is ‘not’ and & is ‘intersect’), | is ‘union’ and @ is ‘belong to’)

| | |
|---|---|
| Expression | Natural Language |
| A&B\|C&D=o | (1) There are no bats which feed on blood and no |
| | other mammal which feeds on mosquitoes in this |
| | area. |
| B&C@D&E | (2) All of the bats which feed on mosquitoes are |
| | mammals which are good for human beings. |
| A&D&E>˜B&C&D | (3) We know, except the bat, mammals which feed on |
| | blood and benefit human beings are mammals |
| | which feed on mosquitoes. |

The ecologist makes the following judgment:

| | |
|---|---|
| %(A&D)−(B\|C)=x | “There could be found a kind of mammal, other |
| | than the bat, which feeds on blood rather than |
| | feed on mosquitoes in this area”. |

(The data are premises and the judgment is conclusion).
Do you think the judgment is right or not ?

| | |
|---|---|
| Where | A: animals which feed on blood |
| | B: Bats |
| | C: animals which feed on mosquitoes |
| | D: mammals |
| | E: animals good for human being |

*-*-*-*-*CONTENT OF LIN TABLE OF THIS PROPOSITION *-*-*-*

| | | | | | | | | | | | | | | | | |
|---|---|---|---|---|---|---|---|---|---|---|---|---|---|---|---|---|
| A => | 0 | 1 | 2 | 3 | 4 | 5 | 6 | 7 | 8 | 9 | 10 | 11 | 12 | 13 | 14 | 15 |
| B => | 0 | 1 | 2 | 3 | 4 | 5 | 6 | 7 | 16 | 17 | 18 | 19 | 20 | 21 | 22 | 23 |
| C => | 0 | 1 | 2 | 3 | 8 | 9 | 10 | 11 | 16 | 17 | 18 | 19 | 24 | 25 | 26 | 27 |
| D => | 0 | 1 | 4 | 5 | 8 | 9 | 12 | 13 | 16 | 17 | 20 | 21 | 24 | 25 | 28 | 29 |
| E => | 0 | 2 | 4 | 6 | 8 | 10 | 12 | 14 | 16 | 18 | 20 | 22 | 24 | 26 | 28 | 30 |

****** Begin test infix to postfix and evaluate ****** A&B|C&D=o
(1) There are no bats which feed on
---------- evaluating sequence ----------

| | | | | | | | | | | | | | |
|---|---|---|---|---|---|---|---|---|---|---|---|---|---|
| 0 | 1 | 2 | 3 | 4 | 5 | 6 | 7 | | | | | | |
| 0 | 1 | 8 | 9 | 16 | 17 | 24 | 25 | | | | | | |
| 0 | 1 | 2 | 3 | 4 | 5 | 6 | 7 | 8 | 9 | 16 | 17 | 24 | 25 |
| 0Ø | 1Ø | 2Ø | 3Ø | 4Ø | 5Ø | 6Ø | 7Ø | 8Ø | 9Ø | 16Ø | 17Ø | 24Ø | 25Ø |

B&C@D&E (2) All of the bats which feed on mosquitoes ----------
- evaluating sequence ----------

| | | | | | | | |
|---|---|---|---|---|---|---|---|
| 0 | 1 | 2 | 3 | 16 | 17 | 18 | 19 |
| 0 | 4 | 8 | 12 | 16 | 20 | 24 | 28 |
| 1Ø | 2Ø | 3Ø | 17Ø | 18Ø | 19Ø | | |

A&D&E>˜B&C&D (3) We know, except the bat, mammals which ------------
- evaluating sequence ----------

| | | | | | | | | | | | | | | | |
|---|---|---|---|---|---|---|---|---|---|---|---|---|---|---|---|
| 0 | 1 | 4 | 5 | 8 | 9 | 12 | 13 | | | | | | | | |
| 0 | 4 | 8 | 12 | | | | | | | | | | | | |
| 8 | 9 | 10 | 11 | 12 | 13 | 14 | 15 | 24 | 25 | 26 | 27 | 28 | 29 | 30 | 31 |
| 8 | 9 | 10 | 11 | 24 | 25 | 26 | 27 | | | | | | | | |
| 8 | 9 | 24 | 25 | | | | | | | | | | | | |
| 9Ø | 24Ø | 25Ø | | | | | | | | | | | | | |

0x Ω 4x Ω 12x
%(A&D)−(B|C)=x “There could be found a kind of mammal, --------
----- evaluating sequence ----------

| | | | | | | | |
|---|---|---|---|---|---|---|---|
| 0 | 1 | 4 | 5 | 8 | 9 | 12 | 13 |

| | | | | | | | | | | | | | | | | | | | | | | | | | | | |
|---|---|---|---|---|---|---|---|---|---|---|---|---|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 | 25 | 26 | 27 |

12 13
12x Ω 13x
*********** RESULT OF THE LOGIC CALCULATION ***********
===== Normal part of Premises =====

| | | | | | | | | | | | | | | |
|---|---|---|---|---|---|---|---|---|---|---|---|---|---|---|
| 1. | 0Ø | 1Ø | 2Ø | 3Ø | 4Ø | 5Ø | 6Ø | 7Ø | 8Ø | 9Ø | 16Ø | 17Ø | 24Ø | 25Ø |
| 2. | 1Ø | 2Ø | 3Ø | 17Ø | 18Ø | 19Ø | | | | | | | | |
| 3. | 9Ø | 24Ø | 25Ø | | | | | | | | | | | |

----- Or-connect part of Premises -----
3. 0x Ω 4x Ω 12x
=*= Collection of all premises in the following set
0Ø 1Ø 2Ø 3Ø 4Ø 5Ø 6Ø 7Ø 8Ø 9Ø 16Ø 17Ø 18Ø 19Ø 24Ø 25Ø
=*= Collection of all or-connect in the following set
12x
********** Above premises are CONSISTENT *************
===== Normal part of Conclusions =====
----- Or-connect part of Conclusions -----
1. 12x Ω 13x
*-*-*-*-* Conclusion 1 is a SOUND VALID argument*-*-*-*-*

B. Applications:

There are 5 major applications are defined so far to take advantage of machine understanding or machine intelligence as listed and discussed below. The core technology can be utilized by many more applications beyond the scope of this patent.

Applications base on such highly complex technologies are:

1. Conceptual Search Engine on multimedia:
Instead of like most of natural-language concept-based search engine (typical SVM [Support Vector Machine] technology are used) conduct exhaust training and subject/theme analysis, the current disclosure use pre-defined expressions/model (in text or graphically) as members of concept set to accelerate searching performance. And instead of using SVM to do search, we use it for learning purpose only at this time for the system to grow its intelligence.
This search engine is unique, in that it can
A) Not only conduct text search but also graphic search.
   For example, Search engine user many query text mode requests like the following regular expressions, where NP stand for Noun Phrase.
   E.g. 1, NP is replaced as ‘RF’
      ‘What is NP?’, ‘Is NP safety really important?’,
   E.g. 2, NPs are replaced as ‘dog’, ‘tail’
      ‘Why some NP1 are without NP2?’
   E.g. 3, NP is replaced as ‘electricity’ etc. . . .
      ‘How NP works?’, ‘When was NP invented?’,
      ‘Who discovered NP?’, ‘Where can we find NP?’
   If an user issue a query and select concept search option (as oppose to keyword or phrase search), the search system should provide means to allow user fully express their idea, and the system should do its best to detect and identify user's true intention, for example, if user issue a search request: “What is RF?” in natural language, then the search engine should find articles that explain RF by:
B) Paring engine matches the queried word, what, and identify what is an interrogative pronoun, and “is” is a be verb, and RF is a noun or an adjective. If understand word of ‘what’ and ‘is’ as a concept of looking an equivalence of a thing, a synonym; but don't know what is ‘RF’ yet, the engine then look the concept IOT table to find whether there is an exact match term in ‘CONCEPT_IOT.DESCRIPTION’ field call ‘RF’, and found 2 entries as below, so the parsing engine ask user back to resolve an ambiguity (if the user select the interactive mode of search, else it will categorize the data and pass found items down to translation engine)
   dictionary store RF is=“Radio Frequency”
   RF is an independent research institute
   Else if it is not in dictionary or only one is found, then the parsing engine will locate the concept ID.
C) Translation engine accept all concept IDs found by parsing engine then transverse the network of concept links for both text mode and graphic mode.
   The concept links keep track of synonyms of “What is” request links as follows:
   The noun can be interchange between ‘RF’ and ‘Radio Frequency’, eg.
   “What is RF”, “What is Radio Frequency”, “What is Radio Frequency(RF)”
      “RF is”,
      ‘RF means’,
      ‘RF stands for’,
      ‘Radio Frequency(RF):”,
      ‘Definitions for RF:’
      “RF refers to”
      “Rxxxxx fxxxxxxx, or RF” refers to”,
   As previous point out, this set of ‘What is” concept, we only looking for consistency among them and worry about the completeness of members later.
   System need to have option sidebar to go through ‘hierarchical’ selection or “just show me”, if hierarchical then it will automatic categories RF types:
   In this case it prompts selections of
      Radio Frequency
      an independent research institute
   The system will not return any thing that use RF as modified, e.g.
      “RF Engines”,
      “RF Toolbox”,
      “RF Micro Devices”,
      “RF transceiver”,
      “RF Safety”
   Because user asks an noun RF not and adjective RF
   Install the system include an object-relational database system to prepare hosting vast amount of ‘words’, ‘phrases’, concepts, ‘facts’ and ‘rules’, we'll install the initial test data set. Future learning will dynamically expand the size of the database. The database is capable of store various media type such as
      Structured table (row/column) fields to host traditional data.
      Unstructured text, articles, web pages
      Video: host images, video stream, or audio alone. (prepare in phase II)
      Spatial data and other hyper multi-dimensional data.
   The system is initially tested with the following interrogative words:
      What (pron. adj.), why(conj.), who, when, where, how,
   The Search Engine has 5 parts:
   I. The first part of the search engine works on the internal database structure (represented by the DDLs (Data Definition Languages, e.g. ‘Create’ statement mentioned above), and use DML (Data Manipulation Language) and such as Oracle PL/SQL in a package in the form of object programming style inside our hybrid database system. The object programming has polymorphism the same as the ‘concept’ which has same hierarchical functionality path from abstract toward concrete and members (but work on different data types) in the same class (set).
   II. Crawling through web pages: We'll customize free-domain crawler utility, this crawler use DNS entries to start a tree of searching. Crawling through web pages: industrial leading search engines usually isolate this step and do it when the Internet is less busy, it then caches the retrieved data into their own local storage and index or hash the keywords into massive multiple partitions physically locate in different hardware for fast parallel retrieval.
   III. Index:
      There are 3 types of indexes/hashing types, as depicted in the Core Technology section above.
      Text mode index:
      Graphic Mode index:
      Spatial Data index and Relationship reasoning:
   IV. Scan through content:
      Below is an example of how the conceptual search works:
         a. Scan through content by matching a concept (set) under certain subjects, by matching each of its members with content of a web pages or article. This task can be parallelized to enhance the performance. The score of a searched object will be kept for relevance evaluation.
      b. There are 2 types of output requirement,
         1) First response: just show me as soon as there is one match, can be further dissect into class (first few dozen objects) and return the local sorting result.
         2) Highest relevant: wait until all searches are done, so we can sort and get the highest relevant f
   V. Relevance evaluation: sort the high relevance if the “highest relevant” mode is wanted, else if the ‘fastest response’ option select, it only sort the relevance based on the first set of data return locally, and present to user immediately.
   Search Engine Configuration interface.
      a. for retrieving data or facts from “memory (an object database)” or
      b. conduct new facts search,
      c. or just letting the user input premises, or
      d. Let the user modify automatically collected facts, and output conclusion and searching statistics.

2. Inference Engine:
Inference engine can be a stand alone application which works on concept level of inference.
After the search engine returns found pages, articles, which might contains duplicated facts or inconsistencies, the inference engine will use inference rules in propositional logic with predicate logic to reach its goal by following sequence:
   A) Make found and filtered facts unique in the returned document list, then
   B) Collected facts/situation as premises of an argument,
   C) Check the consistency among premises. It may vote the inconsistent premises out through its learning (neuro-network based) experience, or ask for a consultation from human only if needed Oust like we do).
   D) Process the passed a conclusion, judgment or hypothesis from plan manager and then validate the argument. Or simply show all the details found by the inference engine to the user, helping scientist/engineer to conduct the analysis.
The conclusion may be indirectly or directly relate to the goal that the user or an autonomous system is looking for, if indirectly related, the user or a plan manager of an autonomous system will call to inference engine with next step requirement to satisfy the ultimate goal.

3. Translation Engine:
Translation goes beyond vocabulary and lexicon mapping among languages into context-based conceptual translation. Since concept covers grammar belongingness of a word and consider the surroundings of other concepts spotted (see FIG. 7) as context. Conceptual translation can be more precise than just word-to-word match between languages.

4. Human Machine Conversation:
Built on top the conceptual search and translation capability, by adding the context tracking capability, these abilities enable the machine conversation to pass ‘Turing Test’, in that the human can't distinguish he or she is talking to a machine-or a real person.

5. Autonomous System:
By harness the machine cognition based on sensation and perception at abstractive concept level, machine can be more flexible and intelligent to response to request from higher level modules. The planner or system manager module if given with a goal, they will try to find out concepts of:
i) What category of this goal is? (understand the concept of ‘goal’, and classification by matching words in the description and transverse the nodes bottom up as see in FIG. 7 to locate the subject)
ii) What environment/context that I'm in? (Understand the given data—could be a few paragraphs or automatic data collection by audio-visual 3D I/O tracking and behave understanding, or Internet/library search, etc. . . . )
iii) What resource that I. can use? (by given from description or conceptual search or reasoning)
iv) What constraints that I'm limited to?
v) What technique that I've learned can be applied to this problem to achieve the goal?
For example, this is a problem that the proposed system can solve, it is related to schedule transportation in space stations, and the input source could come from voice recognition (FIG. 1):
A team of 4 astronauts need to cross from a dangerous site A to safe site B due to emergency evacuation (goal a: category: efficient transportation), Astronaut A is hurt slightly, B is fine, but condition degrading, the other 2 are fine. (Context, situation, environment)
They only have 1 space vehicle to use, but the power is down; (constraints) Site A is going to run out of oxygen (like the Apollo 13 situation) in 14 minutes (goal b) according to sensor report.
   [Constraint starts
The 2-man vehicle is switched to manual mode, the moving speed of the vehicle that protect astronauts from harmful surroundings rely on the manpower to push it.
If astronaut A is moved alone it takes 8 minutes to reach the safe site B,
If astronaut B alone take 5 minutes,
If astronaut C alone take 2 minutes,
If astronaut D alone take 3 minutes,
If 2 astronauts go together it will take their average (2 bodies weight/2 mans' power) Constraints end]
How can you help to save all astronauts? (Goal c, without sacrificing anyone)
(You should stop here and try to figure out the answer yourself before you check the solution provide below by the autonomous system)
The system will understand these statements and spot the following concepts:
   1) goal: to save all astronauts, across from site A to site B in 14 minutes
   2) environment: site A is dangerous because oxygen will run out in 14 minutes, and site B is safe
   3) resources: 2-man vehicle
   4) constraints:
      i. only 1 vehicle and
      ii. need to transport people back and forth use man power, and
      iii. Each person is limit to their max speed, which also take time, e.g. 8, 5, 2, 3 minutes individually.
      iv. If 2 people go together in the vehicle, time is consumed by their average.
The system will apply the concepts and technique of
   1) what is the ‘goal’: the plan manager tries to resolve its goal by asking search engine to look in the concept_ID which described as ‘goal’, parsing engine first spot initial keyword, then gets the members of goal concept set by the internal database part of the searching engine E.g. members in ‘goal set are “how”, “how to”, “can you”, “is it possible to”, etc. . . .
   2) repeat the previous process to find what is the ‘environment’, ‘resources’, ‘constraints’?
   3) Summarize sub goals to find out the problem category concept (FIG. 5, Concept_IOT), and find the response (Response_NT) where records the procedure to solve this type of problem by finding field specific concepts of the follows (polymorphism functions or members in a class as in object programming language):
      a. what is the “minimum” concept group (will have many member functions) and apply sorting algorithm(e.g. qsort( ) in C) on the data: 2, 3, 5, 8 (for astronaut C, D, B, A)
         pick 2 and 3 as minimum group of 2 (because 2-man vehicle) Note, min ( ) functions are defined in many function prototypes use object-oriented program (the Formal Language here is the C++ language):
         e.g. (by looking at the prototype specification below, average programmer can figure out the detail implementation below, some of interpreter can dynamically handle different data types, but compilers typically require detail data type being specified)
         min(int array[], int n) for return first n element from a sorted list,
         min(char* array[], int n) for return first n element from a sorted list,
         min(int a, int b) return the smaller integer.
         min(float a, float b) return the smaller integer.
         min(char a, char b) . . .
      b. what is the “maximum” group?:
         pick 5 and 8 as maximum group of 2 (similar to item a. above)
      c. (technique guidelines from Response_NT in FIG. 5, 6) have members in the minimum group running vehicle back and forth and have maximum group just do one way trip.
      d. Permutation algorithm start with heuristic from item c. above, select the permutation that satisfy the goal in 14 minutes, listed below:

(Denote as “Astronaut Time” such as A8, B5, C2, and D3 for easier reading)

Status at Sites after each moving ([v] = vehicle):

| | Site A | Direction | Site B | Cumulated minutes: |
|---|---|---|---|---|
| Step | (dangerous) | (mover) = time | (safe) | agv(float a, float b) |
| 0 | A8, B5, C2, D3 [v] | | | 0 |
| 1 | A8, B5 | to(C, D) = 2.5 | C2, D3 [v] | 2.5 |
| 2 | B5, A8, C2 [v] | back(C) = 2 | D3 | 2.5 + 2.0 = 4.5 |
| 3 | C2 | to(A, B) = 6.5 | A8, B5, D3 [v] | 4.5 + 6.5 = 11.0 |
| 4 | C2, D3 [v] | back(D) = 3 | A8, B5 | 11.0 + 3.0 = 14.0 |
| | (astronaut leave site A immediately after D3 back to site A) | | | |
| 5 | | to(C, D) = 2.5 | A8, B5, C2, D3 [v] | 14.0 + 2.5 = 16.5 |

By 4 steps, all the astronauts are safe escape from life threaten location site A, and with 5 steps everyone reach a safe place site B, without this type of planner, it is very difficult for a human to resolve such complicate problem under an emergent emotional pressure.

FIG. 9 is a block diagram showing the multimedia conceptual search system according to an embodiment of the present invention. As shown in FIG. 9, the multimedia conceptual search system 90 includes a user interface 91, a hybrid database 92, a parsing engine 93, a translation engine 94, and a search engine 95. The user interface 91 receives user query data for search from a user 97, and then transforms the user query data into a user query expression, such as a text, an image, a graphic object, etc. The hybrid database 92 stores a plurality of entries, each of which has at least one meaning identifier (ID) and each meaning ID is corresponding to a concept ID. The parsing engine 93 parses the user query expression to determine at least one matching entry, which the user query expression contains, within the entries of the hybrid database 92, and determines at least a matching concept ID of the user query expression according to the at least one matching entry. One of the at least one meaning ID of each matching entry is corresponding to the matching concept ID. The translation engine 94 translates the user query expression to other equivalent expressions according to the entries each has one meaning ID corresponding to the matching concept ID. Next, the search engine searches a storage media for any relevant object stored therein according to the user query expression and the other equivalent expressions. Then, the search results are returned through the user interface 91.

When the user query expression is a text, the system 90 is operated in a text mode as shown in FIG. 5 and FIG. 7. At this case, each matching entry may be a lexicon, a word, a term, a phrase, an idiom, a regular expression, a sentence, etc. The parsing engine 93 determines the meaning ID, which is corresponding to the matching concept ED, of each matching entry according to grammar belongingness of the matching entry in the text. When the user query expression is an image or a graphic object, the system 90 is operated in a graphic mode as shown in FIG. 6 and FIG. 7. At this case, each matching entry may be one or one combination of the following: a shape, a chroma, a texture, a pattern, a size, and an icon. Further, for example, the shape can be represented by a NURBS curve as described above.

FIG. 10 is a flow chart showing the multimedia conceptual search method according to another embodiment of the present invention. As shown in FIG. 10, the flow comprises the steps of:
Step 101: providing a hybrid database including a plurality of entries, wherein each entry has at least one meaning ID, and each meaning ID is corresponding to a concept ID;
Step 102: receiving user query data from a user interface;
Step 103: transforming the user query data into a user query expression;
Step 104: parsing the user query expression to determine at least one matching entry, which the user query expression contains, within the entries of the hybrid database;
Step 105: determining at least a matching concept ID of the user query expression according to the at least one matching entry, wherein one of the at least one meaning ID of each matching entry is corresponding to the matching concept ID;
Step 106: translating the user query expression to other equivalent expressions according to the entries each of which has one meaning ID corresponding to the matching concept ID;
Step 107: searching a storage media for any relevant object stored therein according to the user query expression and the other equivalent expressions; and
Step 108: returning search results through the user interface.

When the user query expression is a text, the above method is performed in a text mode as shown in FIG. 5 and FIG. 7. At this case, each matching entry may be a lexicon, a word, a term, a phrase, an idiom, a regular expression, a sentence, etc. In step 105, the meaning ID, which is corresponding to the matching concept ID, of each matching entry is determined according to grammar belongingness of the matching entry in the text. When the user query expression is an image or a graphic object, the above method is performed in a graphic mode as shown in FIG. 6 and FIG. 7. At this case, each matching entry is one or one combination of the following: a shape, a chroma, a texture, a pattern, a size, and an icon. Further, for example, the shape can be represented by a NURBS curve or other representation methods.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A multimedia conceptual search method comprising steps of:
providing a hybrid database including a plurality of entries, wherein each entry has at least one meaning identifier (ID), and each meaning ID is corresponding to a concept ID;
parsing a user query expression to determine at least one matching entry, which the user query expression contains, within the entries of the hybrid database;
determining at least a matching concept ID of the user query expression according to the at least one matching entry, wherein one of the at least one meaning ID of each matching entry is corresponding to the matching concept ID;
translating the user query expression to other equivalent expressions according to the entries each of which has one meaning ID corresponding to the matching concept ID; and
searching a storage media for any relevant object stored therein according to the user query expression and the other equivalent expressions.

2. The method according to claim 1, further comprising:
receiving user query data from a user interface; and
transforming the user query data into the user query expression.

3. The method according to claim 1, further comprising:
returning search results through a user interface.

4. The method according to claim 1, wherein when the user query expression is a text, the method is performed in a text mode.

5. The method according to claim 4, wherein each matching entry is one of the following: a lexicon, a word, a term, a phrase, an idiom, a regular expression, and a sentence.

6. The method according to claim 5, wherein the meaning ID, which is corresponding to the matching concept ID, of each matching entry is determined according to grammar belongingness of the matching entry in the text.

7. The method according to claim 1, wherein when the user query expression is an image or a graphic object, the method is performed in a graphic mode.

8. The method according to claim 7, wherein each matching entry is one or one combination of the following: a shape, a chroma, a texture, a pattern, a size, and an icon.

9. The method according to claim 8, wherein the shape is represented by a Non-Uniform Rational B-spline (NURBS) curve.

10. A multimedia conceptual search system comprising:
a hybrid database for storing a plurality of entries, wherein each entry has at least one meaning identifier (ID), and each meaning ID is corresponding to a concept ID;
a parsing engine for parsing a user query expression to determine at least one matching entry, which the user query expression contains, within the entries of the hybrid database, and for determining at least a matching concept ID of the user query expression according to the at least one matching entry, wherein one of the at least one meaning ID of each matching entry is corresponding to the matching concept ID;
a translation engine for translating the user query expression to other equivalent expressions according to the entries each of which has one meaning ID corresponding to the matching concept ID; and
a search engine for searching a storage media for any relevant object stored therein according to the user query expression and the other equivalent expressions.

11. The system according to claim 10, further comprising:
a user interface for receiving user query data and transforming the user query data into the user query expression.

12. The system according to claim 10, further comprising:
a user interface for returning search results.

13. The system according to claim 10, wherein when the user query expression is a text, the system is operated in a text mode.

14. The system according to claim 13, wherein each matching entry is one of the following:
a lexicon, a word, a term, a phrase, an idiom, a regular expression, and a sentence.

15. The system according to claim 14, wherein the parsing engine determines the meaning ID, which is corresponding to the matching concept ID, of each matching entry according to grammar belongingness of the matching entry in the text.

16. The system according to claim 10, wherein when the user query expression is an image or a graphic object, the system is operated in a graphic mode.

17. The system according to claim 16, wherein each matching entry is one or one combination of the following: a shape, a chroma, a texture, a pattern, a size, and an icon.

18. The system according to claim 17, wherein the shape is represented by a Non-Uniform Rational B-spline (NURBS) curve.
